(19) United States
(12) Patent Application Publication
(10) Pub. No.: US 2010/0037914 A1
(43) Pub. Date: Feb. 18, 2010

(54) DEVICE, SYSTEM, AND METHOD FOR THE TREATMENT OF FADED OR OXIDIZED ANODIZED ALUMINUM

(76) Inventor: Paul Miller, Berkeley Lake, GA (US)

Correspondence Address: CROSE LAW LLC, 112 NORTHBROOKE TRACE, WOODSTOCK, GA, 30188, US

(21) Appl. No.: 12/191,357

(22) Filed: Aug. 14, 2008

(51) Int. Cl. B08B 7/00; A47L 13/10

(52) U.S. Cl. 134/6; 15/209.1

(57) ABSTRACT

The technology described herein provides an applicator pad, system, and method for the treatment of faded or oxidized anodized aluminum. The applicator pad includes a central foam core, and an outer cloth covering, the outer cloth covering being substantially smooth and disposed upon and securely adhered to the soft foam core, the outer cloth covering configured to receive and transfer a predetermined measure of polymer to the foam core and for direct application contact with the faded or oxidized anodized aluminum. The system for treating faded or oxidized anodized aluminum includes an applicator pad, a clear gloss, satin, or mat finish polymer, a polymer remover, a cloth, a sandpaper sheet, and an instructional guide. A method for treating faded or oxidized anodized aluminum includes utilizing an applicator pad and a clear gloss, satin, or mat finish polymer for removing the appearance of oxidation from anodized aluminum, elucidating the aluminum, and secondarily providing a protective coat.

### FIELD OF THE INVENTION

The technology described herein relates generally to the fields of cleaning and treating metals. More specifically, this technology relates to devices, systems, and methods of use for the treatment of faded or oxidized anodized aluminum. Furthermore, this technology relates to the treatment of faded or oxidized anodized aluminum on exterior surfaces on consumer products such as window moldings, automotive and boat trim pieces, and the like.

### BACKGROUND OF THE INVENTION

Since aluminum is known to be structurally weakened by oxidation, it is often anodized through various known chemical acid baths and other processes to create a surface coating and make the aluminum stronger and more durable. Anodized aluminum is utilized in the manufacture of many products. For example, anodized aluminum is utilized in window moldings, cookware, outdoor furniture, automotive and boat trim pieces, wheels, etc. Over time, such consumer products manufactured with anodized aluminum can fade and oxidize, giving a faded, white, chalky, water-marked appearance. By way of example, an automotive trim piece manufactured from anodized aluminum can develop a faded, white, chalky, water-marked appearance, deteriorating the overall appearance and beauty of the automobile.

Related patents known in the art include the following. U.S. Pat. No. 7,318,871, issued to Egan et al. on Jan. 15, 2008, discloses a vehicular cleaning concentrate. U.S. Pat. No. 6,562,142, issued to Barger, et al. on May 13, 2003, discloses a system and method for cleaning and/or treating vehicles and the surfaces of other objects. U.S. Pat. No. 4,532,065, issued to Cohen, et al. on Jul. 30, 1985, discloses a method and composition for cleaning anodized aluminum. U.S. Pat. No. 7,348,302, issued to Smith on Mar. 25, 2008, discloses a foam cleaning and brightening composition comprising a sulfate/bisulfate salt mixture. U.S. Pat. No. 6,511,532, issued to Matzdorg, et al. on Jan. 28, 2003, discloses a post-treatment for anodized aluminum. U.S. Pat. No. 5,439,747, issued to Sturdevant, et al. on Aug. 8, 1995, discloses an anodized aluminum having protective coating. U.S. Pat. No. 4,897,231, issued to Scheurer, et al. on Jan. 30, 1990, discloses an anodized aluminum coating. U.S. Pat. No. 4,310,390, issued to Bradley, et al. on Jan. 12, 1982, discloses a protective coating process for aluminum and aluminum alloys. U.S. Pat. No. 4,512,677, issued to Trinh on Apr. 23, 1985, discloses a no rinse liquid car cleaner kit with liquid cleaner and bristle pad. U.S. Pat. No. 5,472,512, issued to Gober, et al. on Dec. 5, 1995, discloses a process for cleaning aluminum and tin surfaces. U.S. Pat. No. 5,538,600, issued to Schultz, et al. on Jul. 23, 1996, discloses a method for desmutting aluminum alloys having a highly-reflective surface. U.S. Pat. No. 6,440,290, issued to Vega, et al. on Aug. 27, 2002, discloses a method for surface treating aluminum products. U.S. Pat. No. 7,166,205, issued to Kuo, et al. on Jan. 23, 2007, discloses a method for producing hard surface, colored, anodized aluminum parts. U.S. Pat. No. 5,387,290, issued to Kolinsky on Feb. 7, 1995, discloses a hand polishing technique for automobiles and other vehicles. U.S. Pat. No. 5,802,655, issued to Denton on Sep. 8, 1998, discloses a cleaner-wiper package. U.S. Pat. No. 5,408,718, issued to Sadovsky on Apr. 25, 1995, discloses a combination cleaning pad.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides for the treatment of faded or oxidized anodized aluminum. Devices, systems, and methods are disclosed for the treatment of faded or oxidized anodized aluminum on exterior surfaces on consumer products such as window moldings, automotive and boat trim pieces, and the like, in order to eliminate or reduce the faded, white, chalky, water-marked appearance on an anodized aluminum surface, to elucidate the aluminum, and to provide a protective coat.

In one exemplary embodiment, the technology described herein provides an applicator pad for use in the treatment of faded or oxidized anodized aluminum. The applicator pad includes: a central foam core, the central foam core being substantially soft, flexible, and compressible, and an outer cloth covering, the outer cloth covering being substantially smooth and disposed upon and securely adhered to the soft foam core, the outer cloth covering configured to receive and transfer a predetermined measure of polymer and for direct application contact with the faded or oxidized anodized aluminum.

The combined central foam core and outer cloth covering are rolled such that the central foam core comprises an interior of the applicator pad and the outer cloth covering comprises an exterior of the applicator pad and the applicator pad comprises a generally elongated, flattened, tubular shape for ease of use and disposition within a hand of an operator. The outer cloth covering can be permanently adhered to the central foam core with glue or sonically adhered, and, once adhered, back-rolled to itself to leave the outer cloth as an outer covering, thereby allowing passage of a liquid between the outer cloth and the central foam core. The central foam core can include a plurality of foam layers. The outer cloth covering can include a plurality of cloth layers.

In another exemplary embodiment, the technology described herein provides a system for the treatment of faded or oxidized anodized aluminum. The system includes an applicator pad comprising a central foam core, the central foam core being substantially soft, flexible, and compressible and an outer cloth covering, the outer cloth covering being substantially smooth and disposed upon and securely adhered to the soft foam core, the outer cloth covering configured to receive and transfer a predetermined measure of polymer and for direct application contact with the faded or oxidized anodized aluminum, a polymer for disposition, in predetermined measure, upon the applicator pad and for subsequent application contact upon the faded or oxidized anodized aluminum, and a polymer remover to use if the polymer runs or is misapplied in order to prepare the faded or oxidized anodized aluminum for reapplication with the polymer.

The system also includes a cloth for dampening and subsequent wiping with a continuous stroke of a treatment surface of the faded or oxidized anodized aluminum prior to application of the polymer with the applicator pad in order to remove surface grit and dirt. The system also includes a sandpaper sheet for sanding a treatment surface of the faded or oxidized anodized aluminum prior to application of the polymer with the applicator pad in order to remove surface oxidation. The system also includes an instructional guide having instructions for application of the polymer to the applicator pad and subsequent application to the faded or oxidized anodized aluminum. The system can also include a media file containing audio and video instructions for application of the polymer to the applicator pad and subsequent application to the faded or oxidized anodized aluminum. In various embodiments, the polymer is a water-based clearcoat gloss polymer, a solvent-based clearcoat gloss polymer, or a gloss clearcoat of any type.

In yet another exemplary embodiment, the technology described herein provides a method for the treatment of faded or oxidized anodized aluminum. The method includes: utilizing an applicator pad comprising a central foam core, the central foam core being substantially soft, flexible, and compressible and an outer cloth covering, the outer cloth covering being substantially smooth and disposed upon and securely adhered to the soft foam core, the outer cloth covering configured to receive and transfer a predetermined measure of polymer and for direct application contact with the faded or oxidized anodized aluminum, applying a clear gloss, satin, or mat finish polymer, of predetermined measure, to the applicator pad, and applying the clear gloss, satin, or mat finish polymer to the faded or oxidized anodized aluminum to remove any oxidation. The faded or oxidized anodized aluminum comprises a first end and a second end and wherein applying the clear gloss polymer comprises wiping the applicator pad containing the polymer from one of the first and second ends to the other, thereby applying the polymer in a continuous, uninterrupted motion from end-to-end.

The method also includes: utilizing a cloth for dampening and subsequent wiping with a continuous stroke of a treatment surface of the faded or oxidized anodized aluminum prior to application of the polymer with the applicator pad in order to remove surface grit and dirt, dampening the cloth, and wiping the dampened cloth upon the faded or oxidized anodized aluminum with a continuous stroke to remove surface grit and dirt.

The method also includes: utilizing a sandpaper sheet for sanding a treatment surface of the faded or oxidized anodized aluminum prior to application of the polymer with the applicator pad in order to remove surface oxidation, and sanding the treatment surface of the faded or oxidized anodized aluminum to remove surface oxidation. In various embodiments, sanding the treatment surface comprises wet sanding. In various embodiments, the predetermined measure of polymer is applied to the applicator pad in triplicate such that three dots of a same quantity of polymer are contiguously placed upon the applicator pad in linear fashion.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a perspective view of an applicator pad for use in the clarification and protection of faded or oxidized anodized aluminum, according to an embodiment of the technology;

FIG. 2 is a perspective view of the applicator pad of FIG. 1, illustrating, in particular, varied layers of the applicator pad and aspects of one method of construction and assembly of the applicator pad, according to an embodiment of the technology;

FIG. 3 is a perspective view of a damp towel for use in the clarification and protection of faded or oxidized anodized aluminum, illustrating, in particular, use of the damp towel for removal of surface dirt and grit from an anodized aluminum surface, according to an embodiment of the technology;

FIG. 4 is a perspective view of sandpaper for use in the clarification and protection of faded or oxidized anodized aluminum, illustrating, in particular, use of the sandpaper for removal of surface oxidation from an anodized aluminum surface, according to an embodiment of the technology;

FIG. 5 is a perspective view of the inversion of a bottle containing a polymer to deliver a dot a polymer to the applicator pad of FIG. 1, according to an embodiment of the technology;

FIG. 6 is a perspective view of the applicator pad of FIG. 1, illustrating, in particular, an applied first dot of polymer for use in the clarification and protection of faded or oxidized anodized aluminum, according to an embodiment of the technology;

FIG. 7 is a perspective view of the applicator pad of FIG. 1, illustrating, in particular, applied first and second dots of polymer for use in the clarification and protection of faded or oxidized anodized aluminum, according to an embodiment of the technology;

FIG. 8 is a perspective view of the applicator pad of FIG. 1, illustrating, in particular, applied first, second, and third dots of polymer for use in the clarification and protection of faded or oxidized anodized aluminum, according to an embodiment of the technology;

FIG. 9 is a perspective view of the applicator pad of FIG. 1, illustrating, in particular, application of the polymer from the loaded applicator pad to a trim piece of anodized aluminum, according to an embodiment of the technology; and

FIG. 10 is a flowchart diagram depicting a method for the clarification and protection of faded or oxidized anodized aluminum, according to an embodiment of the technology.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides for the clarifying and protection of faded or oxidized anodized aluminum. Devices, systems, and methods are disclosed for the treatment of faded or oxidized anodized aluminum on exterior surfaces on consumer products such as window moldings, automotive and boat trim pieces, and the like, in order to eliminate or reduce the faded, white, chalky, water-marked appearance on an anodized aluminum surface, to primarily elucidate the aluminum, and to secondarily provide a protective coat.

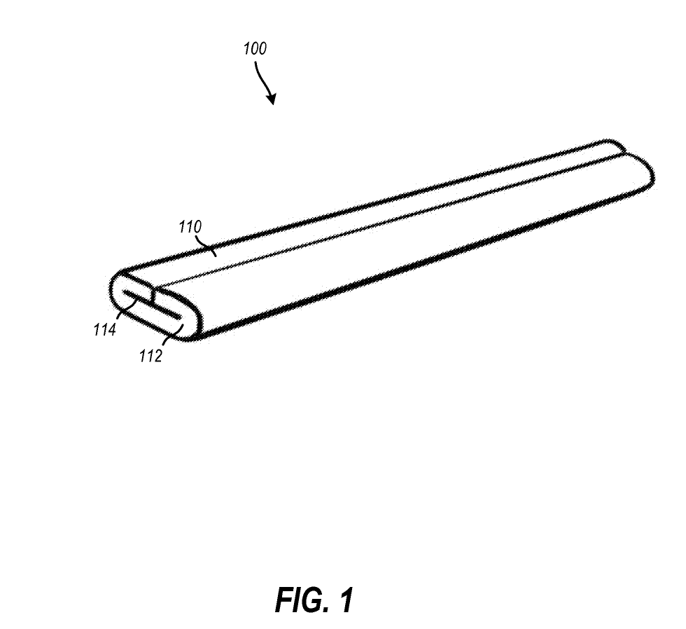

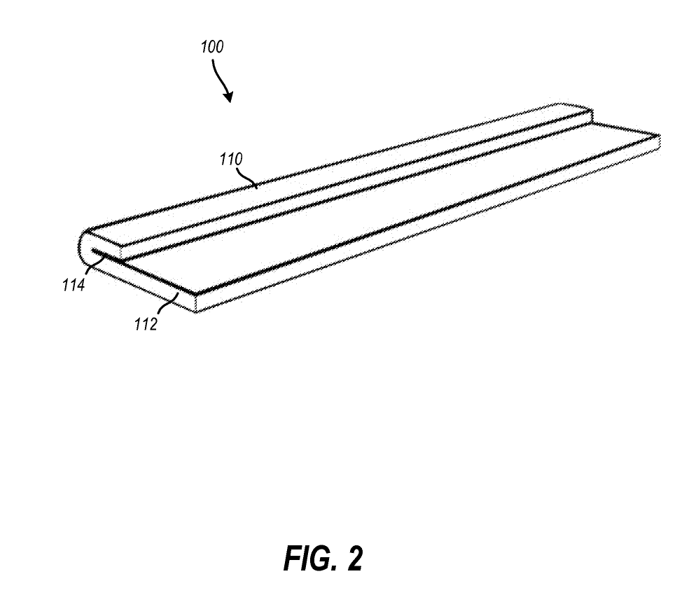

Referring now to FIGS. 1 and 2, an applicator pad 100 for use in the clarification and protection of faded or oxidized anodized aluminum is shown. The applicator pad 100 includes a central foam core 112. The central foam core 112 is soft, flexible, and compressible. The central foam core 112 provides retention of softness and a moderate resistance to compression. The central foam core 112 can vary in elasticity and density. The central foam core 112 can be manufactured with a multiplicity of foam layers.

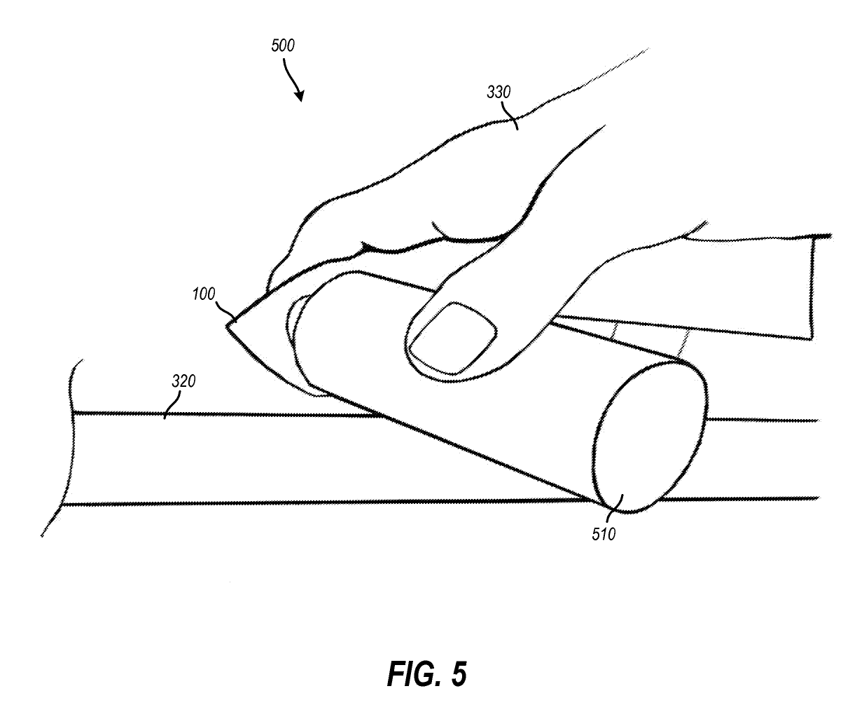

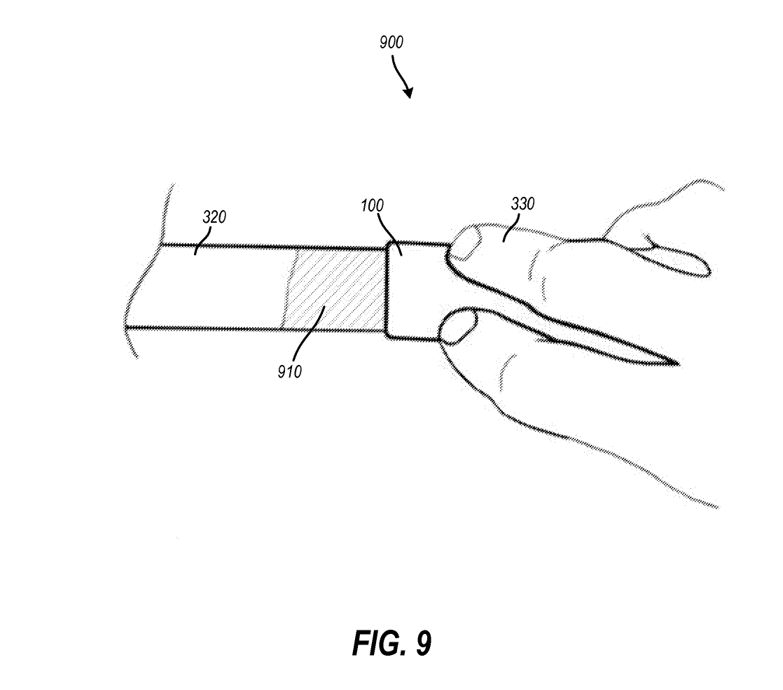

The applicator pad 100 also includes an outer cloth covering 110. The outer cloth covering 110 is very smooth such that it will not scratch or otherwise harm the surface of the aluminum upon which it is applied, and allow a smooth application of polymer to the oxidized surface. The outer cloth covering 110 can be a fabric or fibrous material that is woven, knitted, pressed, or the like, such as, for example, but not limited to, cotton, wool, or synthetic fibers. The outer cloth covering 110 can be manufactured of a multiplicity of cloth layers. The outer cloth covering 110 is adhered to the central foam core 112, layer upon layer, with glue or other means that securely holds the outer cloth covering 110 to the central foam core 112, allowing passage of liquid. The outer cloth covering 110 is configured to receive and transfer a predetermined measure of polymer to the central core (as shown in FIGS. 5 through 8) and for direct application contact with the faded or oxidized anodized aluminum (as shown in FIG. 9).

The combined central foam core 112 and outer cloth covering 110 can be rolled (as shown in FIG. 2) such that the central foam core 112 comprises an interior of the applicator pad 100 and the outer cloth covering 110 comprises an exterior surface of the applicator pad 100. In such a configuration, the applicator pad 100 is held together along line 114 with glue, or any means of bonding including ultra sound and the like. Thus, the applicator pad 100 can form a generally elongated, flattened, tubular shape for ease of use and disposition within a hand of an operator.

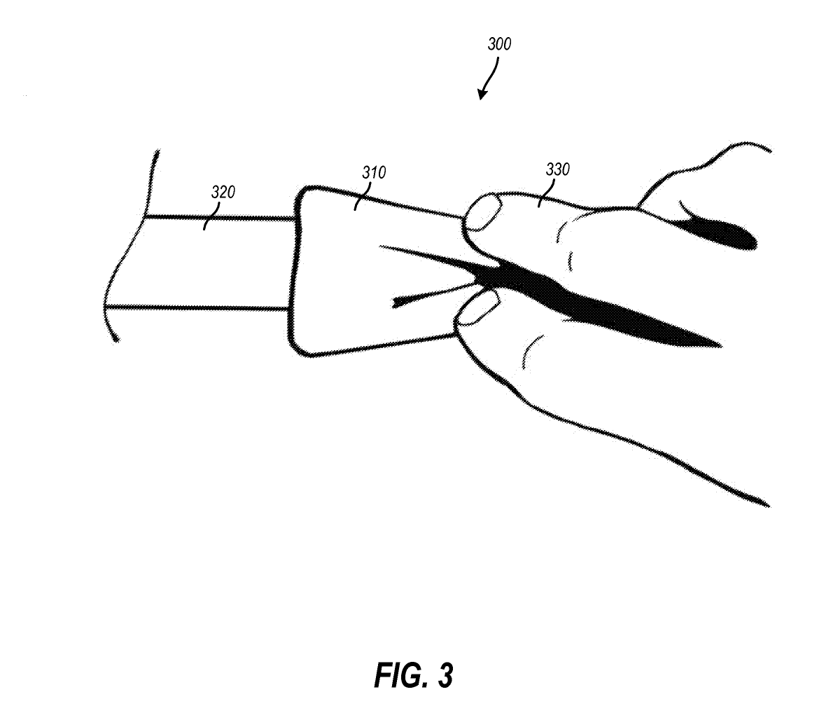

Referring now to FIG. 3, diagram 300 illustrates a method step in which the faded or oxidized anodized aluminum is treated prior to application of the polymer. A cloth 310 for use in the treatment and protection of faded or oxidized anodized aluminum is shown. The cloth 310 is used prior to application of polymer for removal of surface dirt and grit from an anodized aluminum surface. The cloth 310 can be a water-dampened towel. Optionally, the cloth 310 can be dampened and utilized with a mild cleaner. By way of example, alcohol can be used on the cloth 310.

By way of example, cloth 310 is held by the hand 330 of an operator, dampened by water and/or cleaner, and utilized upon an anodized aluminum trim piece 320. The use of the cloth 310 is in a continuous, non-stop motion beginning at a first end of trim piece 320 and ending at a second end of trim piece 320. All surface grit and dirt must be removed prior to application of the polymer to prevent scratching of the anodized aluminum surface trim piece 320.

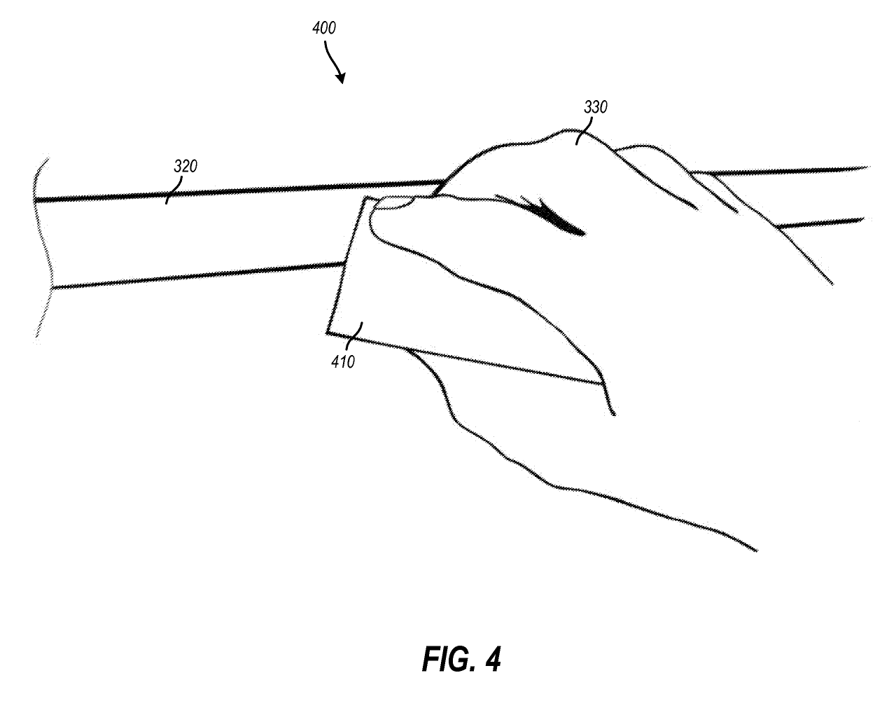

Referring now to FIG. 4, diagram 400 illustrates another method step in which the faded or oxidized anodized aluminum is treated prior to application of the polymer is shown. A sandpaper sheet 410, or similar coated abrasive, for use in the treatment and protection of faded or oxidized anodized aluminum is shown. The sandpaper sheet 410 is used after the cloth 310 is used (FIG. 3), and prior to application of polymer, for removal of surface oxidation, and staining from an anodized aluminum surface.

Sandpaper 410 of varying degrees of grit size can be utilized. For example, on anodized aluminum with higher degrees of surface oxidation, staining, and fading coarser sandpaper, or sandpaper with a lower grit size number, is utilized. In such cases when coarse sandpaper is desired, 600-800 grit sandpaper that has been previously used is applied to the anodized aluminum surface trim piece 320 in order to address the deeper oxidation while, at the same time, not scratching the trim piece 320. A sandpaper sheet 410 of grit sizes 1000, 1500, and 2000, for example, can be utilized to address varying degrees of oxidation on the trim piece 320. The sandpaper sheet 410 can be wetted and used in wet-sanding, which is effective in addressing varying degrees of surface oxidation on anodized aluminum.

By way of example, the sandpaper sheet 410 is held by the hand 330 of an operator and utilized upon an anodized aluminum trim piece 320. The use of the sandpaper sheet 410 can be in a back-and-forth motion along the trim piece 320. As the sanding process continues, a white, chalky slurry appears. The slurry consists of the removed surface oxidation and water. As the slurry becomes clearer, it is apparent there is less oxidation and more water in the slurry. Once clear, the slurry is considered to be free from surface oxidation from the sanding process. As the sanding process ends, a cloth 310 is dampened and utilized in a continuous, non-stop motion from end-to-end of the trim piece 320 to remove any remaining sanded oxidation and moisture from the surface of the anodized aluminum trim piece 320. A cloth 310 that is kept dry is also utilized in a continuous, non-stop motion from end-to-end of the trim piece 320 after the cloth 310 that is dampened. All surface oxidation must be removed prior to application of the polymer to the anodized aluminum surface trim piece 320.

Referring now to FIG. 5, diagram 500 illustrates a method step in which the faded or oxidized anodized aluminum is treated with application of the polymer. The method by which a predetermined amount of polymer is applied to the applicator pad 100 is specific. Application of too much polymer to the applicator pad 100 can result in running. Application of too little polymer to the applicator pad 100 can result in skipping surface areas along the trim piece 320, for example. Both polymer misapplications provide undesirable results.

In the event too much or too little polymer has been applied causing an unacceptable result, two remedies are provided for removing the polymer. In one remedy, lacquer thinner is used to smooth any irregularities in the polymer coating, and continued wiping with lacquer thinner will completely remove the polymer coating in preparation for re-application. In a second remedy, a full strength ammonia solution can be applied to the unacceptable dried water-based polymer coating, and allowed to remain on for about two minutes. After this time, the misapplied polymer coating, having been chemically modified by the ammonia solution, peels up like a thin skin and is removed in preparation for re-coating.

As shown, the polymer is stored in small bottle 510. The small bottle 510 is convenient for use and is easily utilized in a cleaning kit. The polymer can be stored in other receptacles as well, such as a tube, sprayer, or the like. The polymer can be a water-based polymer or a solvent-based gloss, satin, or mat finish clearcoat polymer. By way of example, a water-based clearcoat can include titanium dioxide CAS#13463-67-7, water CAS#7732-18-5, oxygenated hydrocarbon CAS#25265-77-4, water soluble polyurethane CAS#57-55-6, and diethylene glycol butyl ether CAS#112-34-5. The water-based clearcoat can, as is sometimes necessary due to local climate and other factors, be diluted for optimal application. By way of example, a dilution ratio of 50/50, or 50% water/50% water-based clearcoat can be utilized. The ratio is modified as necessary based on temperature, geographical, and other factors. Additionally, the treatment surface can be warmed or cooled as needed, prior to the polymer application, to optimize the application of the water-based clearcoat.

By way of example, the bottle 510 is opened and the applicator pad 100 is held over the bottle opening by the hand of the operator 330 as illustrated. The bottle 510 is inverted and then returned upright in order to deliver a predetermined measure of polymer to the applicator pad 100. The amount of polymer disbursed from the bottle 510 during the inversion resembles a dot on the applicator pad 100. By way of example, the quantity of polymer represented by each dot is approximately 1/64^{th} to ⅛^{th} of an ounce dependent upon the treatment surface.

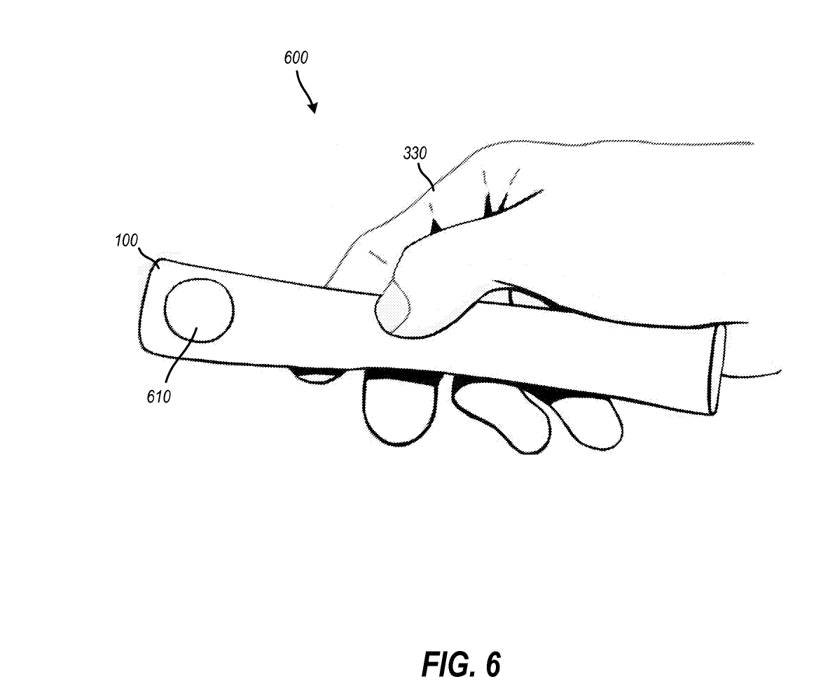

Referring now to FIGS. 6, 7, and 8, diagrams 600, 700, and 800, respectively, are shown to illustrate the quantity and location of polymer applied to the applicator pad 100. The applicator pad 100 is held by the hand of the operator 330. The amount of polymer disbursed from the bottle 510 during the first inversion of the bottle 510 generally resembles a dot 610 on the applicator pad 100. As shown, the dot 610 is generally round and is less than the width of the applicator pad 100. The dot 610 is placed on the applicator pad 100 just inside a length edge. The dot 610 is representative of a predetermined quantity of polymer.

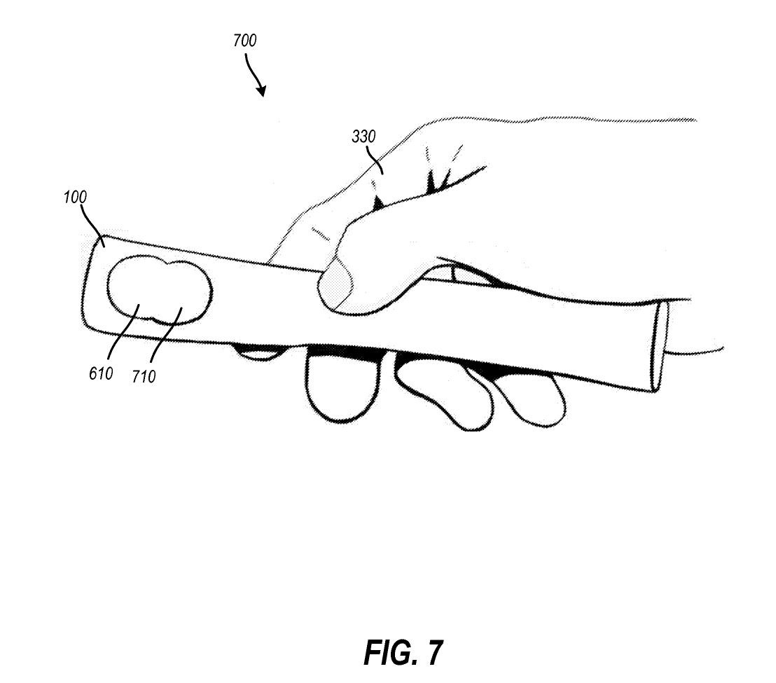

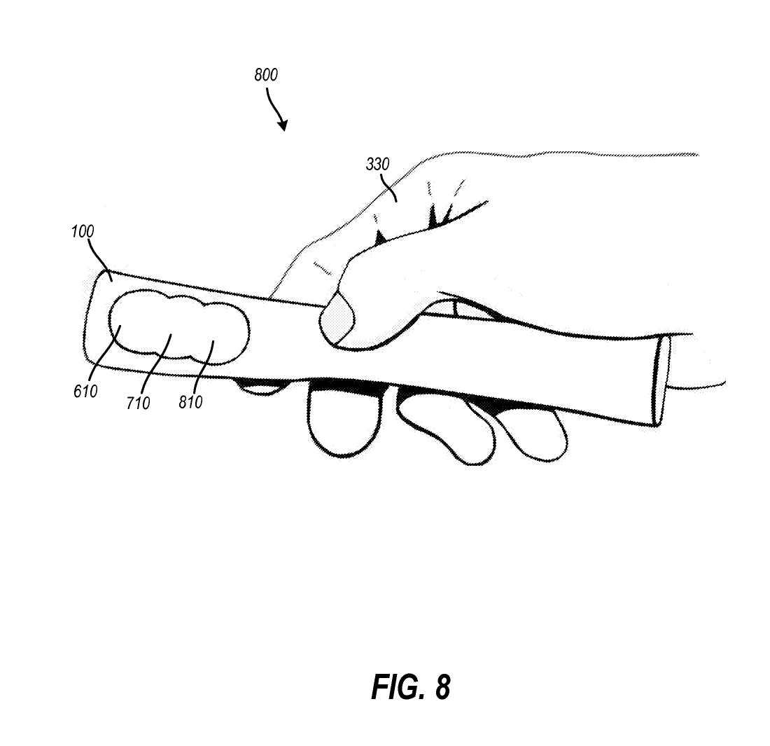

The amount of polymer disbursed from the bottle 510 during the second inversion of the bottle 510 generally resembles a dot 710 on the applicator pad 100. As shown (in FIG. 7) the placement of the second dot 710 is adjacent, and connected to, the first dot 610. The amount of polymer disbursed from the bottle 510 during the third inversion of the bottle 510 generally resembles a dot 810 on the applicator pad 100. As shown (in FIG. 8) the placement of the third dot 810 is adjacent, and connected to, the second dot 710. This specific method, and the quantity and location of the polymer applied to the applicator pad 100, provides a consistent starting point for loading the applicator pad 100 and applying the polymer to the trim piece 320.

Referring now to FIG. 9, diagram 900 illustrates application of the loaded applicator pad 100 to the trim piece 320 to treat the faded or oxidized anodized aluminum. The loaded pad 100 is held in the hand of an operator 330. The loaded pad 100 is placed at one end of the trim piece 320 and is drawn along the length of the trim piece 320 in a continuous, uninterrupted manner, terminating at the opposite end of the trim piece 320. This technique transfers the polymer onto the trim piece 320. The applied polymer 910 is shown. The continuous, uninterrupted manner of the polymer application is significant in order to allow the applied polymer to be flowed on and allowed to relax and dry. By way of example, because the polymer tends to dry quickly, use of multiple, overlapping, rubbing strokes are not desirable because they tend to create an irregular surface finish. Additionally, undesirable bubbles and dimples can form into the coating surface. Thus, the continuous, uninterrupted manner of the polymer application is significant to provide desirable, aesthetic results.

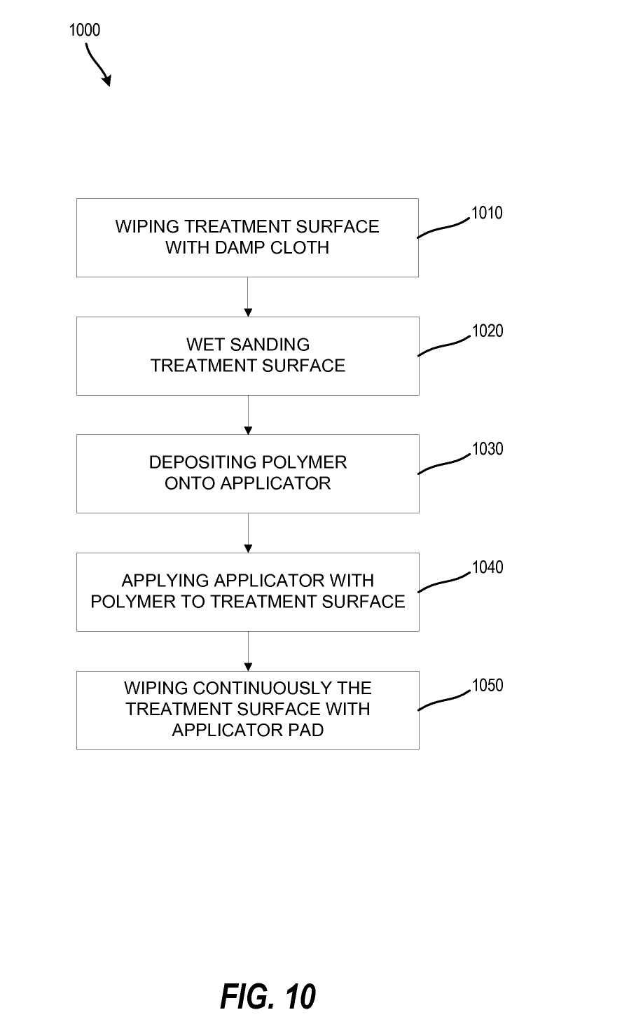

Referring now to FIG. 10, a flowchart diagram 1000 is shown illustrating a method by which faded or oxidized anodized aluminum is treated to eliminate or reduce the faded, white, chalky, water-marked appearance on an anodized aluminum surface, to elucidate the aluminum, and secondarily provide a protective coat. In step 1010, the faded or oxidized anodized aluminum is treated with a cloth 310 (as shown in FIG. 3) prior to application of the polymer. The cloth 310 is used prior to application of polymer for removal of surface dirt and grit from an anodized aluminum surface. The cloth 310 can be a water-dampened towel. Optionally, the cloth 310 can be dampened and utilized with a mild cleaner.

In step 1020 the faded or oxidized anodized aluminum is treated with a sandpaper sheet 410 (as shown in FIG. 4), or similar coated abrasive. The sandpaper sheet 410 is used after the cloth 310 is used and prior to application of polymer, for removal of surface oxidation, and staining from an anodized aluminum surface. The use of the sandpaper sheet 410 is in a back and forth motion beginning at a first end of trim piece 320 and ending at a second end of trim piece 320. As the sanding process continues, a white, chalky slurry appears. The slurry consists of the removed surface oxidation and water. As the slurry becomes clearer, it is apparent there is less oxidation and more water in the slurry. Once clear, the slurry is considered to be free from surface oxidation from the sanding process. As the sanding process ends, a cloth 310 is dampened and utilized in a continuous, non-stop motion from end-to-end of the trim piece 320 to remove any remaining sanded oxidation and moisture from the surface of the anodized aluminum trim piece 320. A cloth 310 that is kept dry is also utilized in a continuous, non-stop motion from end-to-end of the trim piece 320 after the cloth 310 that is dampened. All surface oxidation must be removed prior to application of the polymer to the anodized aluminum surface trim piece 320.

In step 1030 the polymer is applied to the applicator pad 100. The method by which a predetermined amount of polymer is applied to the applicator pad 100 is specific. As shown in FIGS. 6, 7, and 8, the applicator pad 100 can be loaded with three contiguous, linear dots of a predetermined measure of polymer. This specific method, and the quantity and location of the polymer applied to the applicator pad 100, provides a consistent starting point for loading the applicator pad 100 and applying the polymer to the trim piece 320. Single additional dots of polymer are added as needed during the coating process to maintain optimal wetness.

In step 1040 the polymer on the loaded applicator pad 100 is transferred and applied to the faded or oxidized anodized aluminum. In step 1050, the polymer is applied in a continuous, uninterrupted manner. The continuous, uninterrupted manner of the polymer application is significant in order to allow the applied polymer to be flowed on and allowed to relax and dry. By way of example, because the polymer tends to dry quickly, use of multiple, overlapping, rubbing strokes are not desirable because they tend to create an irregular surface finish. Additionally, undesirable bubbles and dimples can form into the coating surface. The continuous, uninterrupted manner of the polymer application is significant to provide desirable, aesthetic results. Multiple applications and coatings of polymer can be applied as desired by adding additional dots of polymer to maintain optimal wetness.

Prior to these methods steps, the surface area surrounding to the faded or oxidized aluminum can be protected. For example, when the aluminum is a trim piece on an automobile, tape can be placed along all sides of the trim piece in order to protect the surrounding paint, windows, etc. from the wiping, sanding, and polymer application.

A system for the treatment of faded or oxidized anodized aluminum is disclosed. The system can be utilized, for example but not limited to, in an automobile or boat cleaning kit, or the like. The system includes an applicator pad 100 having a central foam core 112, the central foam core 112 being substantially soft, flexible, and compressible and an outer cloth covering 114, the outer cloth covering 114 being substantially smooth and disposed upon and securely adhered to the soft foam core 112, the outer cloth covering 114 configured to receive and transfer a predetermined measure of polymer and for direct application contact with the faded or oxidized anodized aluminum, and a polymer for disposition, in predetermined measure, upon the applicator pad 100 and for subsequent application contact upon the faded or oxidized anodized aluminum. Alternatively, a spraying or brushing device is utilized for application of the polymer.

The system also includes a cloth 310 for dampening and subsequent wiping of a treatment surface of the faded or oxidized anodized aluminum prior to application of the polymer with the applicator pad 100 in order to remove surface grit and dirt. The system also includes a sandpaper sheet 410 for sanding a treatment surface of the faded or oxidized anodized aluminum prior to application of the polymer with the applicator pad 100 in order to remove surface oxidation. The system can also include an instructional guide having instructions for application of the polymer to the applicator pad 100 and subsequent application to the faded or oxidized anodized aluminum. The system can also include a media file containing audio and video instructions for application of the polymer to the applicator pad 100 and subsequent application to the faded or oxidized anodized aluminum. In various embodiments, the polymer contained within the cleaning kit is a water-based clearcoat gloss, satin, or mat finish polymer, a solvent-based clearcoat gloss, satin, or mat finish polymer, or a gloss, satin, or mat finish clearcoat of any type, including, for example, but not limited to, an ultraviolet (UV) cured polymer.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. An applicator pad for use in the treatment of faded or oxidized anodized aluminum, the applicator pad comprising:
a central foam core, the central foam core being substantially soft, flexible, and compressible; and
an outer cloth covering, the outer cloth covering being substantially smooth and disposed upon and securely adhered to the soft foam core, the outer cloth covering configured to receive and transfer a predetermined measure of polymer to the soft foam core and for direct application contact with the faded or oxidized anodized aluminum.

2. The applicator pad of claim 1, wherein the combined central foam core and outer cloth covering are rolled such that the central foam core comprises an interior of the applicator pad and the outer cloth covering comprises an exterior of the applicator pad and the applicator pad comprises a generally elongated, flattened, tubular shape for ease of use and disposition within a hand of an operator.

3. The applicator pad of claim 1, wherein the outer cloth covering is permanently adhered to the central foam core with glue or sonically adhered, and, once adhered, back-rolled to itself to leave the outer cloth as an outer covering, thereby allowing passage of a liquid between the outer cloth and the central foam core.

4. The applicator pad of claim 1, wherein the central foam core is comprised of a plurality of foam layers.

5. The applicator pad of claim 1, wherein the outer cloth covering is comprised of a plurality of cloth layers.

6. A system for the treatment of faded or oxidized anodized aluminum, the system comprising:
an applicator pad comprising a central foam core, the central foam core being substantially soft, flexible, and compressible and an outer cloth covering, the outer cloth covering being substantially smooth and disposed upon and securely adhered to the soft foam core, the outer cloth covering configured to receive and transfer a predetermined measure of polymer to the soft foam core, and for direct application contact with the faded or oxidized anodized aluminum;
a polymer for disposition, in predetermined measure, upon the applicator pad and for subsequent application contact upon the faded or oxidized anodized aluminum; and
a polymer remover to use if the polymer runs or is misapplied in order to prepare the faded or oxidized anodized aluminum for reapplication with the polymer.

7. The system of claim 6, further comprising:
a cloth for dampening and subsequent wiping with a continuous stroke of a treatment surface of the faded or oxidized anodized aluminum prior to application of the polymer with the applicator pad in order to remove surface grit and dirt.

8. The system of claim 6, further comprising:
a sandpaper sheet for sanding a treatment surface of the faded or oxidized anodized aluminum prior to application of the polymer with the applicator pad in order to remove surface oxidation.

9. The system of claim 6, further comprising:
an instructional guide having instructions for application of the polymer to the applicator pad and subsequent application to the faded or oxidized anodized aluminum.

10. The system of claim 6, further comprising:
a media file containing audio and video instructions for application of the polymer to the applicator pad and subsequent application to the faded or oxidized anodized aluminum.

11. The system of claim 6, wherein the polymer is a water-based clearcoat polymer.

12. The system of claim 6, wherein the polymer is one of a solvent-based clearcoat polymer and an ultraviolet-cured clearcoat.

13. The system of claim 6, wherein the polymer is one of a gloss, satin, or mat finish.

14. The system of claim 6, wherein the polymer is a gloss clearcoat.

15. A method for the treatment of faded or oxidized anodized aluminum, the method comprising:
utilizing an applicator pad comprising a central foam core, the central foam core being substantially soft, flexible, and compressible and an outer cloth covering, the outer cloth covering being substantially smooth and disposed upon and securely adhered to the soft foam core, the outer cloth covering configured to receive and transfer a predetermined measure of polymer to the soft foam core, and for direct application contact with the faded or oxidized anodized aluminum;
applying one of a clear gloss, satin, and mat finish polymer, of predetermined measure, to the applicator pad; and
applying one of a clear gloss, satin, and mat finish polymer to the faded or oxidized anodized aluminum to remove any oxidation.

16. The method of claim 15, wherein the faded or oxidized anodized aluminum comprises a first end and a second end and wherein applying the clear gloss polymer comprises wiping the applicator pad containing the polymer from one of the first and second ends to the other, thereby applying the polymer in a continuous, uninterrupted motion from end-to-end.

17. The method of claim 15, further comprising:
utilizing a cloth for dampening and subsequent wiping with a continuous stroke of a treatment surface of the faded or oxidized anodized aluminum prior to application of the polymer with the applicator pad in order to remove surface grit and dirt;
dampening the cloth; and
wiping the dampened cloth upon the faded or oxidized anodized aluminum with a continuous stroke to remove surface grit and dirt.

18. The method of claim 15, further comprising:
utilizing a sandpaper sheet for sanding a treatment surface of the faded or oxidized anodized aluminum prior to application of the polymer with the applicator pad in order to remove surface oxidation; and
sanding the treatment surface of the faded or oxidized anodized aluminum to remove surface oxidation.

19. The method of claim 18, wherein sanding the treatment surface comprises wet sanding.

20. The method of claim 15, wherein the predetermined measure of polymer is applied to the applicator pad in triplicate such that three dots of a same quantity of polymer are contiguously placed upon the applicator pad in linear fashion.
